(19) United States
(12) Patent Application Publication
(10) Pub. No.: US 2011/0095606 A1
(43) Pub. Date: Apr. 28, 2011

(54) MULTI-INPUT POWER CONVERTING SYSTEM FOR RENEWABLE ENERGIES

(75) Inventor: TING-CHIA OU, Taoyuan County (TW)

(73) Assignee: Institute of Nuclear Energy Research Atomic Energy Council, Executive Yuan, Taoyuan County (TW)

(21) Appl. No.: 12/607,356

(22) Filed: Oct. 28, 2009

(51) Int. Cl. H02J 4/00

(52) U.S. Cl. 307/26

(57) ABSTRACT

The present invention provides a multi-input power converting system for renewable energies capable of integrating and converting various renewable energies so as to achieve energy compensation and thus high-reliability power supply. The multi-input power converting system comprises a multi-input power converter, at least a battery bank and at least a dynamic voltage restorer. The multi-input power converting system is capable of integrating a plurality of renewable energies and outputting DC power to a DC load by way of a DC bus to prevent AD/DC conversion loss and reduce the cost of installing rectifiers. Moreover, the multi-input power converting system is capable of storing surplus power in the battery bank and outputting AC power to an AC load by way of an AC bus or to an AC grid after the AC voltage waveforms or power factors have been compensated by a dynamic voltage restorer.

### 1. FIELD OF THE INVENTION

The present invention generally relates to a multi-input power converting system for renewable energies and, more particularly, to a multi-input power converting system capable of integrating and converting various renewable energies so as to achieve energy compensation and thus high-reliability power supply.

### 2. BACKGROUND OF THE INVENTION

A general electric power converting architecture for renewable energies only uses a single power converting apparatus. As a result, it fails to achieve power conversion between various renewable energies, diversity in electric power dispatch and applications hybrid energies. The conventional power converting apparatus for renewable energies is designed according to the characteristics of various renewable energies. Before different renewable energies such as wind power and photovoltaic are to be integrated and dispatched for compensation, the changes of AC voltage and power have to be taken into considerations.

Electric power dispatch of a microgrid is an important technique for improving the grid reliability, feasibility and thus system security. However, conventional power conversion between renewable energies depends on the power converting apparatus designed according to the power characteristics and maximum power of the renewable energies. Therefore, it fails to achieve diversity and reliability in power supply provided by various renewable energies.

In recent years, the consumer electronic manufacturers have developed consumer electronic appliances such as electronic ballasts, LEDs, DC inverter air-conditioners, DC inverter refrigerators, DC inverter washing machines that use DC inverter controlled technology to achieve power saving. These power-saving products use DC power as the input power.

Therefore, there is need in providing a multi-input power converting system for renewable energies that is capable of integrating and converting various renewable energies so as to achieve energy compensation and thus high-reliability power supply.

### SUMMARY OF THE INVENTION

It is one object of the present invention to provide a multi-input power converting system capable of integrating a plurality of renewable energies and outputting DC power to a DC load by way of a DC bus to prevent AD/DC conversion loss and reduce the cost of installing rectifiers.

It is another object of the present invention to provide a multi-input power converting system capable of storing surplus power in a battery bank and outputting AC power to an AC load by way of an AC bus or to an AC grid after the AC voltage waveforms or power factors have been compensated by a dynamic voltage restorer.

In order to achieve the foregoing objectives, the present invention provides a multi-input power converting system, comprising: a multi-input power converter (MIPC), capable of receiving and converting a plurality of electric energies generated by a plurality of renewable power sources and outputting DC electric power through a DC bus; at least a battery bank, coupled to the multi-input power converter and capable of storing the DC electric power from the multi-input power converter or delivering the DC electric power to the multi-input power converter; at least a dynamic voltage restorer, capable of storing the DC electric power from the multi-input power converter; wherein the DC electric power is delivered to a DC load or to the dynamic voltage restorer before being delivered to an AC grid or an AC load by way of an AC bus.

### BRIEF DESCRIPTION OF THE DRAWINGS

The objects and spirits of the embodiments of the present invention will be readily understood by the accompanying drawings and detailed descriptions, wherein:

FIG. 1 is a schematic diagram of a multi-input power converting system for renewable energies according to the resent invention;

FIG. 2A to FIG. 2D are operation modes of the multi-input power converter according to the present invention; and

FIG. 3 is a table of operation modes of the multi-input power converter according to the resent invention.

### DETAILED DESCRIPTION OF THE PREFERRED EMBODIMENT

The present invention can be exemplified but not limited by various embodiments as described hereinafter.

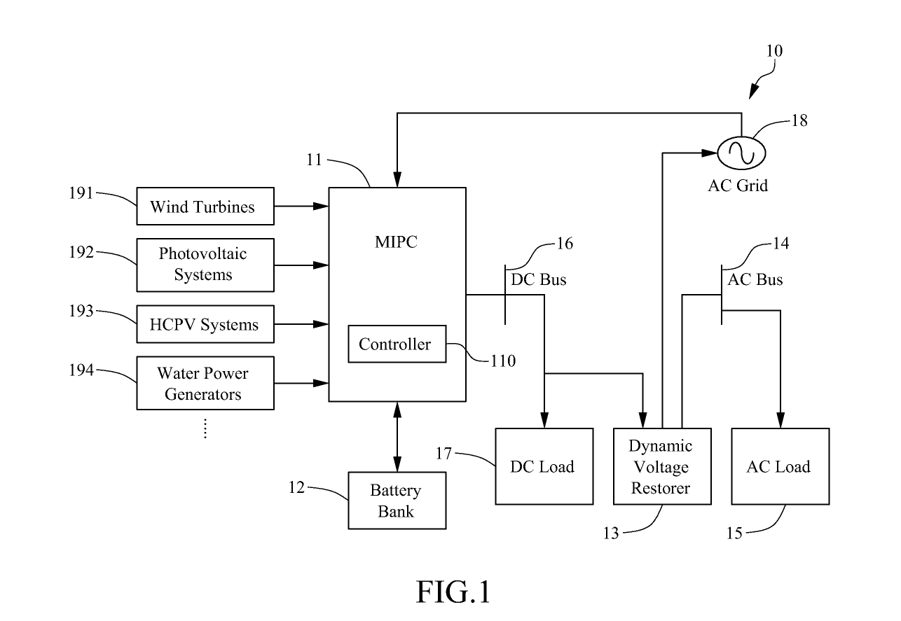

Please refer to FIG. 1, which is a schematic diagram of a multi-input power converting system for renewable energies according to the resent invention. The multi-input power converting system 10 comprises: a multi-input power converter (MIPC) 11, at least a battery bank 12 and at least a dynamic voltage restorer 13.

The multi-input power converter 11 is capable of receiving and converting a plurality of electric energies generated by a plurality of renewable power sources and outputting DC electric power through a DC bus 16. The DC electric power is then delivered to a DC load 17 or to the dynamic voltage restorer 13 before being delivered to an AC grid 18 or an AC load 15 by way of an AC bus 14. In the present embodiment, the renewable power sources include wind turbines 191, photovoltaic systems 192, high-concentration photovoltaic systems 193, water power generators 194 and the like.

The battery bank 12 is coupled to the multi-input power converter 11 and is capable of storing the DC electric power from the multi-input power converter 11 or delivering the DC electric power to the multi-input power converter 11. Moreover, the battery bank 12 is capable of achieving voltage regulation and storing DC electric power. The dynamic voltage restorer 13 is coupled to the DC bus 16, the AC grid 18 or the AC bus 14 and is capable of storing the DC electric power from the multi-input power converter 11 and delivering the DC electric power to the AC grid 18 or the AC bus 14. The dynamic voltage restorer 13 is capable of compensating AC voltage waveform, power factors or controlling the power rates. When the waveform of the voltage at the AC grid 18 is abnormal, the dynamic voltage restorer 13 is capable of compensating the voltage waveform and outputting the compensated voltage waveform to the AC bus 14. Meanwhile, the dynamic voltage restorer 13 receives the DC electric power from the multi-input power converter 11 and delivers the DC electric power to the AC grid 18 or the AC bus 14. Therefore, the dynamic voltage restorer 13 is capable of significantly improving the quality in power supply.

The multi-input power converter 11 further comprises an inverter being capable of converting AC electric energies from the AC grid 18 into DC electric energies. In other words, the multi-input power converter 11 provides the DC load 17 with DC electric power and also dispatches electric energies from the AC grid 18 to the DC load 17 when the DC electric power is insufficient. When there is surplus power in addition to providing the DC load 17 with DC electric power, the multi-input power converting system 10 of the present invention is capable of providing the AC grid 18 with the surplus power from the dynamic voltage restorer 13.

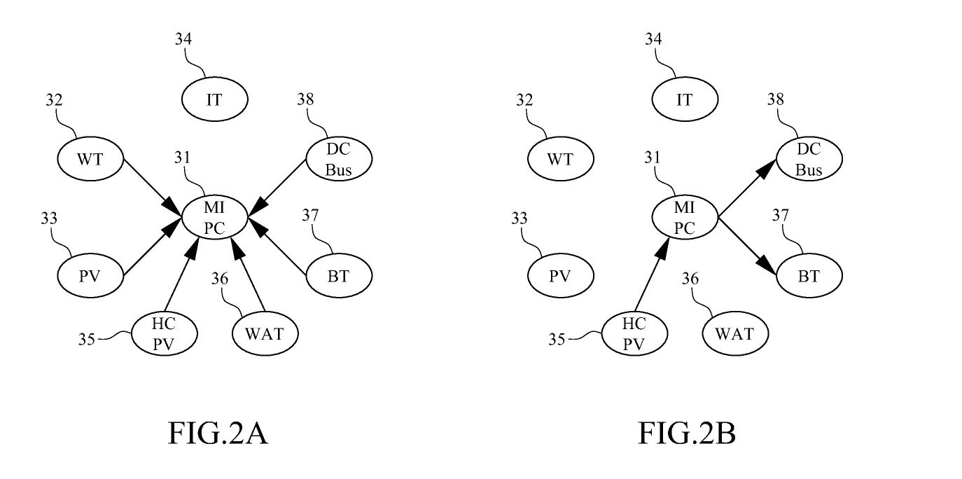

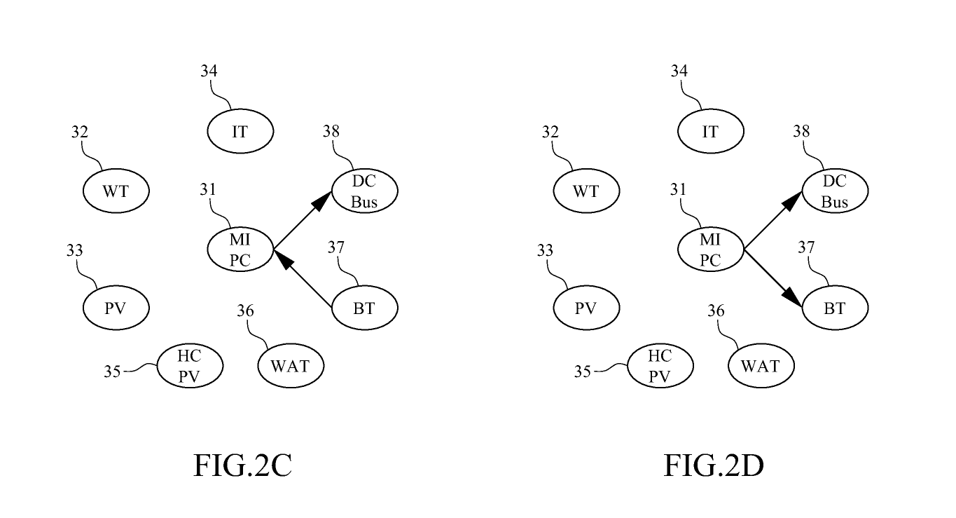

Please refer to FIG. 2A to FIG. 2D for operation modes of the multi-input power converter of the present invention. Referring to FIG. 1 and FIG. 2A to FIG. 2D, the multi-input power converter 11 is capable of receiving wind turbine power P_{WT}, photovoltaic power P_{PV}, high-concentration photovoltaic power P_{HCPV} and water power P_{WAT}. The multi-input power converter 11 is capable of converting the wind power power P_{WT}, the photovoltaic power P_{PV}, the high-concentration photovoltaic power P_{HCPV} and the water power P_{WAT} into net wind power P_{NWT}, net photovoltaic power P_{NPV}, net high-concentration photovoltaic power P_{NHCPV} and net water power P_{NWAT} to provide output DC power P_{dc}.

Considering the power P_{BT} from the battery bank 12 and the power P_{IT} from the AC grid 18 by way of the inverter, the output DC power P_{dc} can be expressed as:

P_{dc}=P_{NWT}+P_{NPV}+P_{NHCPV}+P_{NWAT}±P_{BT}+P_{IT} (1)

wherein the net wind power P_{NWT}, the net photovoltaic power P_{NPV}, the net high-concentration photovoltaic power P_{NHCPV} and the net water power P_{NWAT} can be expressed as:

P_{NWT}=P_{WT}−P_{WTM,loss}=k_{WT}P_{WT} (2)

P_{NPV}=P_{PV}−P_{PVM,loss}=k_{PV}P_{PV} (3)

P_{NHCPV}=P_{HCPV}−P_{HCPVM,loss}=k_{HCPV}P_{HCPV} (4)

P_{NWAT}=P_{WAT}−P_{WATM,loss}=k_{WAT}P_{WAT} (5)

wherein P_{WTM,loss}, P_{PVM,loss}, P_{HCPVM,loss}, P_{WATM,loss} represent the power conversion loss after being converted by the multi-input power converter (MIPC) 11 and k_{WT}, k_{PV}, k_{HCPV} and k_{WAT} are power conversion rates.

In FIG. 2A to FIG. 2D, WT 32 denotes the power delivered from a wind power generator to the multi-input power converter 11, PV 33 denotes the power delivered from a photovoltaic system to the multi-input power converter 11, HCPV 35 denotes the power delivered from a high-concentration photovoltaic system to the multi-input power converter 11, WAT 36 denotes the power delivered from a water power generator to the multi-input power converter 11, BT 37 denotes the power delivered from a battery bank, IT 34 denotes the power delivered from the AC grid 18 by way of an inverter, and MIPC 31 denotes the power delivered from the multi-input power converter 11. DC Bus 38 denotes a DC bus.

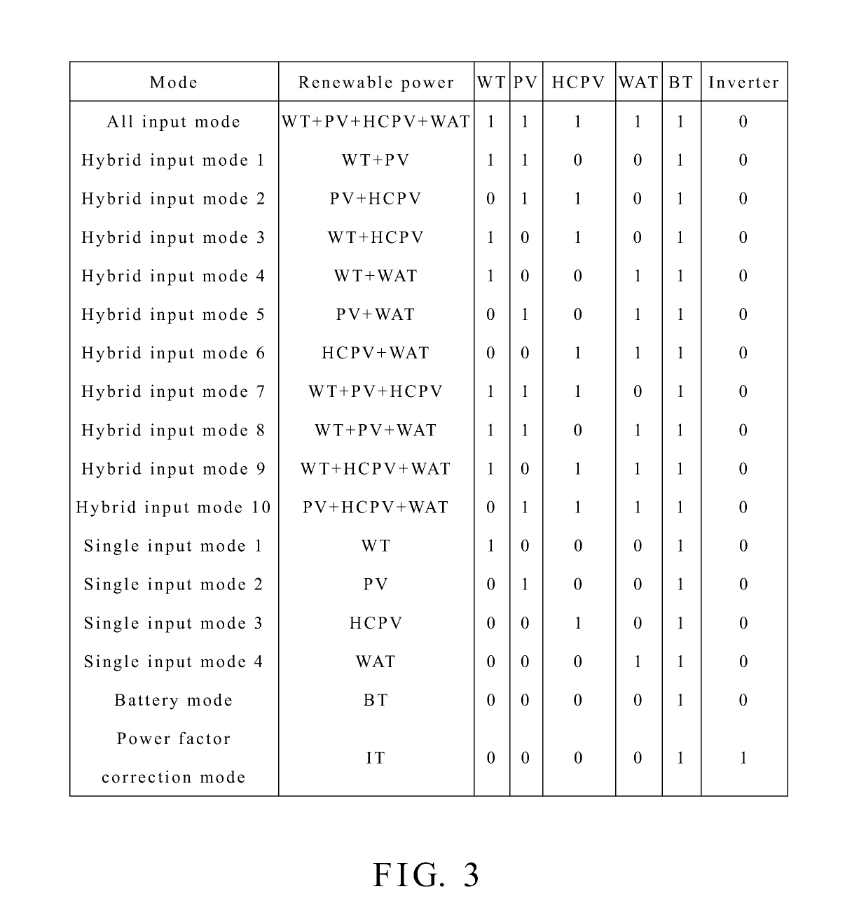

The multi-input power converter 11 further comprises a controller 110 capable of controlling the multi-input power converter 11 to operate in an all input mode, a hybrid input mode, a single input mode, a battery mode or a power factor correction mode. In the all input mode, the multi-input power converter 11 receives the electric energies from all the renewable power sources, as shown in FIG. 2A. In other words, the multi-input power converter 11 receives the electric energies from WT, PV, HCPV and WAT. In the hybrid input mode, the multi-input power converter 11 receives the electric energies from at least two of the renewable power sources. For example, in FIG. 3, the electric energies from the renewable power sources WT and PV are received in the hybrid input mode 1; the electric energies from the renewable power sources PV and HCPV are received in the hybrid input mode 2; the electric energies from the renewable power sources WT and HCPV are received in the hybrid input mode 3; the electric energies from the renewable power sources WT and WATV are received in the hybrid input mode 4; the electric energies from the renewable power sources PV and WAT are received in the hybrid input mode 5; the electric energies from the renewable power sources HCPV and WAT are received in the hybrid input mode 6; the electric energies from the renewable power sources WT, PV and HCPV are received in the hybrid input mode 7; the electric energies from the renewable power sources WT, PV and WAT are received in the hybrid input mode 8; the electric energies from the renewable power sources WT, HCPV and WAT are received in the hybrid input mode 9; and the electric energies from the renewable power sources PV, HCPV and WAT are received in the hybrid input mode 10. In the single input mode, the multi-input power converter 11 receives the electric energy from one of the renewable power sources. As shown in FIG. 2B, the multi-input power converter 11 receives the electric energy from one renewable power source HCPV. In FIG. 3, the electric energy from the renewable power source WT is received in the single input mode 1; the electric energy from the renewable power source PV is received in the single input mode 2; the electric energy from the renewable power source HCPV is received in the hybrid input mode 3; and the electric energy from the renewable power source WAT is received in the single input mode 4.

In the battery mode, the multi-input power converter 11 receives the DC electric power from the battery bank BT and delivers the DC electric power to the DC bus, as shown in FIG. 2C. In the power factor correction mode, the multi-input power converter 11 receives the AC electric energies from the AC grid by way of the inverter IT and delivers the AC electric energies to the DC bus, as shown in FIG. 2D.

The operation modes of the multi-input power converter 11 can be summarized in a table in FIG. 3. More particularly, for renewable power sources WT, PV, HCPV and WAT, “1” represents that the electric energy therefrom is input to the multi-input power converter 11, while “0” represents that the electric energy therefrom is not input to the multi-input power converter 11. For the battery bank BT, “1” represents that the battery bank BT is charged/discharged by the multi-input power converter 11 so that power conversion is stabilized, while “0” represents that the DC electric power therefrom is not input to the multi-input power converter 11. For the inverter IT, “1” represents that the AC electric energy therethrough from the AC grid is input to the multi-input power converter 11 and further delivered to the DC bus, while “0” represents that the AC electric energy therethrough from the AC grid is not input to the multi-input power converter 11.

The present invention discloses a multi-input power converting system for renewable energies that is capable of integrating and converting various renewable energies so as to achieve energy compensation and thus high-reliability power supply. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A multi-input power converting system, comprising:
a multi-input power converter (MIPC), capable of receiving and converting a plurality of electric energies generated by a plurality of renewable power sources and outputting DC electric power through a DC bus;
at least a battery bank, coupled to the multi-input power converter and capable of storing the DC electric power from the multi-input power converter or delivering the DC electric power to the multi-input power converter;
at least a dynamic voltage restorer, capable of storing the DC electric power from the multi-input power converter;
wherein the DC electric power is delivered to a DC load or to the dynamic voltage restorer before being delivered to an AC grid or an AC load by way of an AC bus.

2. The multi-input power converting system as recited in claim 1, further comprising an inverter capable of converting AC electric energies from the AC grid into DC electric energies.

3. The multi-input power converting system as recited in claim 1, wherein the multi-input power converting system is capable of providing the AC grid with surplus power from the dynamic voltage restorer.

4. The multi-input power converting system as recited in claim 1, wherein the multi-input power converter further comprises a controller capable of controlling the multi-input power converter to operate in an all input mode, a hybrid input mode, a single input mode, a battery mode or a power factor correction mode.

5. The multi-input power converting system as recited in claim 4, wherein the multi-input power converter receives the electric energies from all the renewable power sources in the all input mode.

6. The multi-input power converting system as recited in claim 4, wherein the multi-input power converter receives the electric energies from at least two of the renewable power sources in the hybrid input mode.

7. The multi-input power converting system as recited in claim 4, wherein the multi-input power converter receives the electric energy from one of the renewable power sources in the single input mode.

8. The multi-input power converting system as recited in claim 4, wherein the multi-input power converter receives the DC electric power from the battery bank and delivers the DC electric power to the DC bus in the battery mode.

9. The multi-input power converting system as recited in claim 4, wherein the multi-input power converter receives the AC electric energies from the AC grid by way of the inverter and delivers the AC electric energies to the DC bus in the power factor correction mode.
